(19) United States
(12) Patent Application Publication
(10) Pub. No.: US 2020/0386209 A1
(43) Pub. Date: Dec. 10, 2020

(54) METHOD FOR SCREENING CORRELATED SEED TURBINE FOR WIND DIRECTION PREDICTION

(71) Applicant: TONGJI UNIVERSITY, Shanghai (CN)

(72) Inventors: Xiaojun SHEN, Shanghai (CN); Xuejiao Fu, Shanghai (CN)

(73) Assignee: TONGJI UNIVERSITY, Shanghai (CN)

(21) Appl. No.: 16/898,001

(22) Filed: Jun. 10, 2020

(30) Foreign Application Priority Data
Jun. 10, 2019 (CN) 201910496917.8

(51) Int. Cl. F03D 17/00; F03D 7/02; F03D 7/04; G06F 30/17; G01P 13/04

(52) U.S. Cl. CPC F03D 17/00; F03D 7/0204; G06F 2111/10; G06F 30/17; G01P 13/04; F03D 7/048

(57) ABSTRACT

The present invention relates to a method for screening a correlated seed turbine for wind direction prediction. The method includes the following steps: (1) modeling a yaw event of a wind turbine based on a wind direction, a wind speed and a yaw parameter, and obtaining a wind turbine yaw event flag of each wind turbine in a wind farm during a modeling period; (2) classifying and counting the wind turbine yaw event flag, and obtaining a yaw correlation coefficient of other wind turbines each with a target wind turbine in the wind farm; and (3) screening a seed turbine based on the yaw correlation coefficient. Compared with the prior art, the method of the present invention has the advantages of high discriminant validity of the seed turbine, small error, high correlation, and close wind speed characteristics.

### TECHNICAL FIELD

The present invention relates to a method for screening a seed turbine, in particular, to a method for screening a correlated seed turbine for wind direction prediction.

### BACKGROUND

With the continuous development of wind power generation technology, the installed wind power capacity and the single-turbine capacity are continuously increasing. To extend the service life of wind turbines and improve the efficiency of wind energy utilization has become one of the research focuses. Studies show that accurate ultra-short-term wind direction prediction can effectively optimize the working performance of wind turbine yaw systems, extend the operating life and improve the reliability of the wind turbine, and improve wind energy utilization. It is of great engineering value and application prospect to carry out research on wind direction prediction theoretical methods and key technologies for yaw control of wind turbines.

In the actual meteorological environment, there is a strong correlation between wind directions in adjacent areas. It is feasible to use the wind direction correlation between wind turbines in the wind farm to achieve wind direction prediction. In wind direction prediction based on spatial correlation, the selection of correlated turbines is closely related to the accuracy and stability of the wind direction prediction result. Therefore, the selection of correlated turbines is one of the important links of the correlated prediction method.

At present, the correlation is often directly calculated by using wind speed values. With reference to this mathematical intuition, the correlation of wind directions can be analyzed by using a system that directly calculates the correlation by wind direction values, that is, by using a wind direction correlation coefficient method. However, the results of case study found that the wind direction correlation coefficient method had a low discriminant validity for screening the correlated turbine, which is not conducive to the screening of the correlated turbine and cannot guarantee the accuracy of wind direction prediction.

### SUMMARY

An objective of the present invention is to provide a method for screening a correlated seed turbine for wind direction prediction in order to overcome the defects of the prior art as described above.

An objective of the present invention is achieved by the following technical solutions.

A method for screening a correlated seed turbine for wind direction prediction, where the method includes the following steps:

(1) modeling a yaw event of a wind turbine based on a wind direction, a wind speed and a yaw parameter, and obtaining a wind turbine yaw event flag of each wind turbine in a wind farm during a modeling period;

(2) classifying and counting the wind turbine yaw event flag, and obtaining a yaw correlation coefficient of other wind turbines each with a target wind turbine in the wind farm; and

(3) screening a seed turbine based on the yaw correlation coefficient.

In step (1), a value of the wind turbine yaw event flag is {−1,0,1}, where 1 indicates clockwise yaw, −1 indicates counterclockwise yaw, and 0 indicates no yaw.

Step (1) is specifically:

performing steps (11) to (16) for a wind turbine n to obtain a wind turbine yaw event flag, n=1,2 . . . , k, where k is a total number of wind turbines in the wind farm:

(11) setting i=1, where Dₙⁱ is a yaw angle of the wind turbine n at an i^{th} moment; dₙⁱ is a measured wind direction of the wind turbine n at the i^{th} moment;

(12) obtaining a yaw angle Dₙ¹ of the wind turbine n at a 1^{st} moment:

Dₙ¹=dₙ¹;

(13) obtaining a yaw start angle Jₙⁱ of the wind turbine n at the i^{th} moment according to the following formula:

$${J}_{n}^{i} = \{ \begin{matrix}{deg}_{1} , {v}_{n}^{i} \geq {v}_{seg} \\ {deg}_{2} , {v}_{n}^{i} < {v}_{seg}\end{matrix}$$

where, vₙⁱ is a measured wind speed of the wind turbine n at the i^{th} moment; v_{seg} is a set segmented wind speed; deg₁ and deg₂ are set yaw start angles;

(14) calculating a wind deflection angle Δdₙⁱ of the wind turbine n at the i^{th} moment:

$$Δ {d}_{n}^{i} = \{ \begin{matrix}0 & i = 1 \\ {d}_{n}^{i} - {D}_{n}^{i - 1} & i > 1 ;\end{matrix}$$

(15) obtaining a wind turbine yaw event flag Pₙⁱ of the wind turbine n at the i^{th} moment and updating Dₙⁱ according to the following formulas:

$${P}_{n}^{i} = \{ \begin{matrix}1 & , & Δ {d}_{n}^{i} \geq {J}_{n}^{i} \\ - 1 & , & Δ {d}_{n}^{i} \leq - {J}_{n}^{i} \\ 0 & , & - {J}_{n}^{i} \leq Δ {d}_{n}^{i} \leq {J}_{n}^{i} ,\end{matrix} \\ {D}_{n}^{i} = \{ \begin{matrix}{d}_{n}^{i} & , {P}_{n}^{i} \neq 0 \\ {D}_{n}^{i - 1} & , {P}_{n}^{i} = 0 ;\end{matrix}$$

(16) assigning i=i+1, and determining whether i is less than n_{data}; if yes, returning to step (13), otherwise ending, where n_{data} is a total number of moments during the modeling period.

Step (2) is specifically:

numbering the target wind turbine as n₂, and performing steps (21) to (23) for a wind turbine j in the wind farm to obtain a yaw correlation coefficient Q_{j,n}_{₂} of the wind turbine j with the target wind turbine in the wind farm, where |j=1,2, . . . , k., j≠n₂, and k is a total number of wind turbines in the wind farm:

(21) counting a number of times L(1,1) when the wind turbine j and the target wind turbine both yaw with the same yaw event at adjacent moments during the modeling period, a number of times L(1,2) when the wind turbine j yaws but the target wind turbine does not yaw at adjacent moments during the modeling period, a number of times L(2,1) when the wind turbine j does not yaw but the target wind turbine yaws at adjacent moments during the modeling period, and a number of times L(2,2) when the wind turbine j and the target wind turbine both do not yaw at adjacent moments during the modeling period, according to the wind turbine yaw event flag; and

(22) calculating a yaw correlation coefficient Q_{j,n}_{₂} of the wind turbine j with the wind turbine n₂ according to L(1,1), L(1,2), L(2,1), and L(2,2).

Step (21) is specifically:

(21a) counting a number of times n(a,b) when the wind turbine yaw event flag of the target wind turbine is b and the wind turbine yaw event flag of the wind turbine j at the next moment is a during the modeling period, according to the wind turbine yaw event flag, where a and b are {−1,0,1};

(21b) determining L(1,1), L(1,2), L(2,1), and L(2,2) according to the following formulas:

L(1,1)=n(1,1)+n(−1, −1)

L(1,2)=n(1,0)+n(−1,0)

L(2,1)=n(0,1)+n(0, −1)

L(2,2)=n(0,0)

In step (22), Q_{j,n}_{₂} is determined by the following formula:

$${Q}_{j , {n}_{2}} = \frac{L ( 1 , 1 ) \times L ( 2 , 2 ) - L ( 1 , 2 ) \times L ( 2 , 1 )}{L ( 1 , 1 ) \times L ( 2 , 2 ) + L ( 1 , 2 ) \times L ( 2 , 1 )} .$$

Step (3) is specifically:

(31) comparing the yaw correlation coefficient of other wind turbines each with the target wind turbine in the wind farm; and

(32) screening a wind turbine with the strongest correlation as the correlated seed turbine for wind direction prediction.

In step (32), the wind turbine with the strongest correlation is screened according to the following formula:

$$j = arg {max}_{j} \{ {Q}_{1 , {n}_{2}} , {Q}_{2 , {n}_{2}} , ⋯ {Q}_{j , {n}_{2}} , ⋯ {Q}_{k , {n}_{2}} \}$$

where, n₂ is the number of the target wind turbine; Q_{j,n,}_{₂} is the yaw correlation coefficient of the wind turbine j with the target wind turbine, |j=1,2, . . . , k and j≠n₂, and k is a total number of wind turbines in the wind farm.

Compared with the prior art, the present invention has the following advantages.

(1) According to the control principle of a wind turbine yaw system, a wind turbine yaws is related to the wind direction as well as the wind speed at the current moment. In theory, a larger number of times when the same yaw event occurs between wind turbines indicates a stronger yaw event correlation between the wind turbines. Two turbines with high yaw event correlation have high wind direction correlation as well as close wind speed characteristics, which can provide better guidance for the yaw of wind turbines. The fundamental purpose of wind direction prediction of wind turbines is to serve the control of the wind turbine yaw system. Therefore, the present invention screens the correlated turbine based on the yaw event correlation, and can better guarantee the wind direction prediction accuracy of the target wind turbine.

(2) The present invention proposes a method for screening a correlated turbine based on yaw event correlation. The method mathematically models a yaw behavior of a wind turbine. Then, the method calculates the yaw event correlation of other wind turbines with a target wind turbine by using a contingency table Q coefficient method. Finally, the method selects a turbine with the largest yaw correlation value with the target wind turbine as a spatially correlated seed turbine. The present invention avoids the shortcoming of low discriminant validity caused by calculating the correlation directly by using the wind direction, laying the foundation for the accuracy of wind direction prediction based on spatial correlation.

(3) The purpose of the present invention for selecting a correlated seed turbine for wind direction prediction is to guide wind direction prediction of wind turbines and improve the wind direction prediction accuracy of wind turbines. The present invention combines the wind direction, wind speed, and yaw parameter to screen the seed turbine and calculate the yaw correlation coefficient. Therefore, the screened seed turbine has high correlation and close wind speed characteristics, which provides better guidance for wind direction prediction of wind turbines.

### BRIEF DESCRIPTION OF THE DRAWINGS

FIG. 1 is a block diagram of an overall process of a method for screening a correlated seed turbine for wind direction prediction according to the present invention; and

FIG. 2 is a block diagram of a specific process for modeling a wind turbine yaw event to obtain a wind turbine yaw event flag according to the present invention.

### DETAILED DESCRIPTION

The present invention is described in detail below with reference to the accompanying drawings and specific embodiments. It should be noted that the description of following implementations is merely a substantial example, and the present invention is neither intended to limit its application or use, nor being limited to the following implementations.

### EMBODIMENT

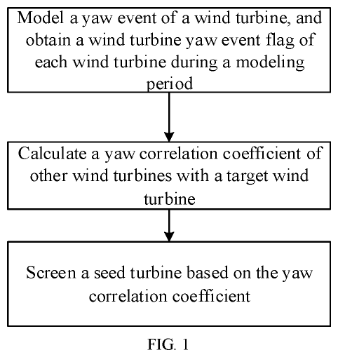

As shown in FIG. 1, a method for screening a correlated seed turbine for wind direction prediction, where the method includes the following steps:

(1) model a yaw event of a wind turbine based on a wind direction, a wind speed and a yaw parameter, and obtain a wind turbine yaw event flag of each wind turbine in a wind farm during a modeling period, where a value of the wind turbine yaw event flag is {−1,0,1}, where 1 indicates clockwise yaw, −1 indicates counterclockwise yaw, and 0 indicates no yaw;

(2) classify and count the wind turbine yaw event flag, and obtain a yaw correlation coefficient of other wind turbines each with a target wind turbine in the wind farm; and

(3) screen a seed turbine based on the yaw correlation coefficient.

The method of the present invention includes: A. mathematically modeling a yaw behavior of a wind turbine; B. calculating correlation of yaw events of wind turbines based on a contingency table Q coefficient; and C. screening a correlated seed based on the yaw correlation.

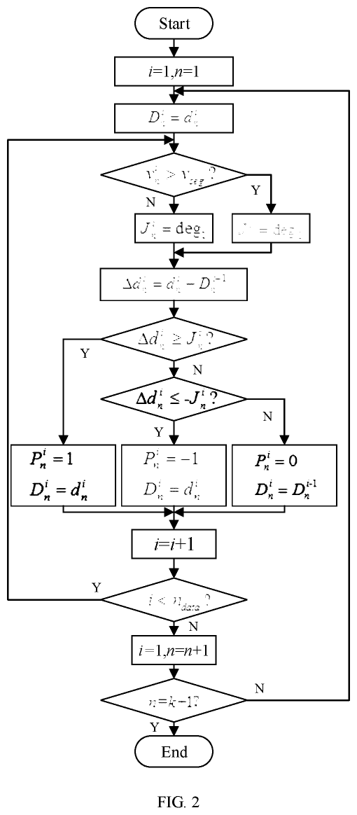

A, mathematically modeling a yaw behavior of a wind turbine, is the content performed in the above step (1). Specifically, as shown in FIG. 2, step (1) is:

perform steps (11) to (16) for a wind turbine n in the wind farm to obtain a wind turbine yaw event flag, n=1,2 . . . , k, where k is a total number of wind turbines in the wind farm:

(11) set i=1, where Dₙⁱ is a yaw angle of the wind turbine n at an i^{th} moment; dₙⁱ is a measured wind direction of the wind turbine n at the i^{th} moment;

(12) obtain a yaw angle Dₙ¹ of the wind turbine n at a 1^{st} moment:

Dₙ¹=dₙ¹;

(13) obtain a yaw start angle Jₙⁱ of the wind turbine n at the i^{th} moment according to the following formula:

$${J}_{n}^{i} = \{ \begin{matrix}{deg}_{1} , {v}_{n}^{i} \geq {v}_{seg} \\ {deg}_{2} , {v}_{n}^{i} < {v}_{seg}\end{matrix}$$

where, vₙⁱ is a measured wind speed of the wind turbine n at the i^{th} moment; v_{seg} is a set segmented wind speed; deg₁ and deg₂ are set yaw start angles;

(14) calculate a wind deflection angle Δdₙⁱ of the wind turbine n at the i^{th} moment:

$$Δ {d}_{n}^{i} = \{ \begin{matrix}0 & i = 1 \\ {d}_{n}^{i} - {D}_{n}^{i - 1} & i > 1 ;\end{matrix}$$

(15) obtain a wind turbine yaw event flag Pₙⁱ of the wind turbine n at the i^{th} moment and update Dₙⁱ according to the following formulas:

$${P}_{n}^{i} = \{ \begin{matrix}1 & , & Δ {d}_{n}^{i} \geq {J}_{n}^{i} \\ - 1 & , & Δ {d}_{n}^{i} \leq - {J}_{n}^{i} \\ 0 & , & - {J}_{n}^{i} \leq Δ {d}_{n}^{i} \leq {J}_{n}^{i} ,\end{matrix} \\ {D}_{n}^{i} = \{ \begin{matrix}{d}_{n}^{i} & , {P}_{n}^{i} \neq 0 \\ {D}_{n}^{i - 1} & , {P}_{n}^{i} = 0 ;\end{matrix}$$

(16) assign i=i+1, and determine whether i is less than n_{data}; if yes, return to step (13), otherwise end, where n_{data} is a total number of moments during the modeling period.

B, calculating correlation of yaw events of wind turbines based on a contingency table Q coefficient, is the content performed in the above step (2).

As the yaw event flag Pₙⁱ is a discrete categorical variable, each value represents a category, and the values cannot be discriminated by size or order. Contingency table is a cross-frequency table that classifies samples according to two or more characteristics. It can concisely and briefly reflect the sample frequencies of two samples under different characteristics. A 2×2 contingency table of yaw events of a wind turbine n₁ and a wind turbine n₂ is constructed, as shown in Table 1, which is used to calculate yaw event correlation.

TABLE 1
Contingency table of yaw events of wind turbines

| Yaw event | n₂ yaws | n₂ does not yaw |
|---|---|---|
| n₁ yaws | L(1, 1) | L(1, 2) |
| n₁ does not yaw | L(2, 1) | L(2, 2) |

Where, L(1,1) represents a number of times when the wind turbine n₁ and the target wind turbine both yaw with the same yaw event at adjacent moments during the modeling period; L(1,2) represents a number of times when the wind turbine n₁ yaws but the target wind turbine does not yaw at adjacent moments during the modeling period; L(2,1) represents a number of times when the wind turbine n₁ does not yaw but the target wind turbine yaws at adjacent moments during the modeling period; L(2,2) represents a number of times when the wind turbine n₁ and the target wind turbine both do not yaw at adjacent moments during the modeling period.

According to the above principle, step (2) is specifically:

number the target wind turbine as n₂, and perform steps (21) to (23) for a wind turbine j in the wind farm to obtain a yaw correlation coefficient Q_{j,n}_{₂} of the wind turbine j with the target wind turbine in the wind farm, where j=1,2, . . . , k., j≠n₂, and k is a total number of wind turbines in the wind farm:

(21) count a number of times L(1,1) when the wind turbine j and the target wind turbine both yaw with the same yaw event at adjacent moments during the modeling period, a number of times L(1,2) when the wind turbine j yaws but the target wind turbine does not yaw at adjacent moments during the modeling period, a number of times L(2,1) when the wind turbine j does not yaw but the target wind turbine yaws at adjacent moments during the modeling period, and a number of times L(2,2) when the wind turbine j and the target wind turbine both do not yaw at adjacent moments during the modeling period, according to the wind turbine yaw event flag; and

(22) calculate a yaw correlation coefficient Q_{j,n}_{₂} of the wind turbine j with the wind turbine n₂ according to L(1,1), L(1,2), L(2,1) and L(2,2)

Step (21) is specifically:

(21a) count a number of times n(a,b) when the wind turbine yaw event flag of the target wind turbine is b and the wind turbine yaw event flag of the wind turbine j at the next moment is a during the modeling period, according to the wind turbine yaw event flag, where a and b are {−1,0,1};

(21b) determine L(1,1), L(1,2), L(2,1) and L (2,2) according to the following formulas:

L(1,1)=n(1,1)+n(−1, −1)

L(1,2)=n(1,0)+n(−1,0)

L(2,1)=n(0,1)+n(0, −1)

L(2,2)=n(0,0)

It should be noted that in the four sets of data in the contingency table, L(2,2) generally accounts for more than 80% of total samples; while the sum of n(1, −1) and n(−1,1) does not exceed 1% of total samples, which has no obvious impact on the calculation of the correlation coefficient, and thus is omitted.

In step (22), Q_{j,n}_{₂} is determined by the following formula:

$${Q}_{j , {n}_{2}} = \frac{L ( 1 , 1 ) \times L ( 2 , 2 ) - L ( 1 , 2 ) \times L ( 2 , 1 )}{L ( 1 , 1 ) \times L ( 2 , 2 ) + L ( 1 , 2 ) \times L ( 2 , 1 )} .$$

The value of the Q_{j,n}_{₂} coefficient is between −1 and 1. A closer Q_{j,n}_{₂} to 1 indicates a larger number of times when the wind turbine j and the target wind turbine (the wind turbine is the wind turbine n₂) have the same yaw event within a fixed time period, that is, the yaw events are positively correlated. A closer Q_{j,n}_{₂} to −1 indicates a larger number of times when the wind turbine j and the target wind turbine have different yaw events within a fixed period of time, that is, the yaw events are negatively correlated. Q_{j,n}_{₂}=0 indicates that the yaw events of the wind turbine j and the target wind turbine are not correlated.

C, screening a correlated seed based on the yaw correlation, is the content performed in the above step (3). Step (3) is specifically:

(31) compare the yaw correlation coefficient of other wind turbines each with the target wind turbine in the wind farm; and

(32) screen a wind turbine with the strongest correlation as the correlated seed turbine for wind direction prediction, where, specifically, in step (32), the wind turbine with the strongest correlation is screened according to the following formula:

$$j = arg {max}_{j} \{ {Q}_{1 , {n}_{2}} , {Q}_{2 , {n}_{2}} , ⋯ {Q}_{j , {n}_{2}} , ⋯ {Q}_{k , {n}_{2}} \}$$

where, n₂ is the number of the target wind turbine; Q_{j,n}_{₂} is the yaw correlation coefficient of the wind turbine j with the target wind turbine, |j=1,2, . . . , k and j≠n₂, and k is a total number of wind turbines in the wind farm.

To sum up, the method for screening a turbine spatially correlated in the wind direction based on yaw correlation is as follows:

Step 1: read a time series of wind speed and wind direction, and input yaw parameters (segmented wind speed v_{seg}, and yaw start angles deg₁, deg₂).

Step 2: model the yaw event, and classify and count Pₙⁱ to obtain L(1,1), L(1,2), L(2,1) and L(2,2).

Step 3: calculate the yaw correlation coefficient Q_{j,n}_{₂} according to the contingency table of L(1,1), L(1,2), L(2,1) and L(2,2).

Step 4: compare the spatial correlation strength of wind direction between all wind turbines and the target wind turbine, and select the most correlated turbine as the correlated turbine for wind direction prediction based on spatial correlation.

To summarize the above, the present invention proposes a method for screening a correlated seed turbine for wind direction prediction. The present invention mathematically models a yaw behavior of a wind turbine. Then, the present invention calculates a yaw event correlation coefficient of a wind turbine with a target wind turbine by using a Q coefficient method. Finally, the present invention selects a turbine with the largest yaw correlation value with the target wind turbine as a spatially correlated seed turbine. The present invention avoids the shortcoming of low discriminant validity caused by calculating the correlation directly by using wind direction, laying the foundation for the accuracy of wind direction prediction based on spatial correlation.

In order to verify the effectiveness of the proposed method for screening a correlated seed turbine for wind direction prediction, the November operation data of 17 wind turbines in a wind farm in North China are selected, and 1,000 consecutive moments are taken to calculate the yaw event correlation of wind direction data of target wind turbines (6 # and 24 # turbines) each with 16 other turbines.

In the calculation of the yaw event correlation, a yaw control strategy of the wind farm is to set a segmented wind speed to be v_{seg=}8 m/s, set a yaw start angle deg₂ to be 8° when the wind speed is greater than 8 m/s, and set a yaw start angle deg₁ to be 16° when the wind speed is less than 8 m/s. The calculation results of wind direction correlation and yaw event correlation are shown in Table 2. In the table, the wind direction correlation coefficient is calculated by using a classic Pearson formula, and the yaw time correlation coefficient is calculated by using the method proposed by the present invention.

TABLE 2
Calculation results of spatial correlation of wind direction between
6 # and 24 # turbines and other wind turbines

| | Target wind turbine 6 # | | Target wind turbine 24# | |
|---|---|---|---|---|
| | Wind direction | Yaw event | Wind direction | Yaw event |
| | correlation | correlation | correlation | correlation |
| Turbine | coefficient | coefficient | coefficient | coefficient |
| No. j | ρ_{j, 6} | Q_{j, 6} | ρ_{j, 24} | Q_{j, 24} |
| 1 | 0.1208 | 0.3459 | 0.0828 | 0.0679 |
| 2 | 0.9443 | 0.5778 | 0.9987 | 0.5197 |
| 3 | 0.5376 | 0.3548 | 0.6191 | 0.3178 |
| 4 | 0.7375 | 0.4138 | 0.8024 | 0.1028 |
| 5 | 0.1406 | 0.7048 | 0.3000 | 0.6791 |
| 6 | 1.0000 | 1.0000 | 0.9463 | 0.5060 |
| 8 | 0.9410 | 0.6622 | 0.9980 | 0.6822 |
| 9 | 0.5757 | 0.3680 | 0.5895 | 0.0582 |
| 11 | 0.1359 | 0.4254 | 0.2894 | 0.5055 |
| 13 | 0.6209 | 0.4134 | 0.7325 | 0.5133 |
| 14 | 0.9427 | 0.1109 | 0.9986 | 0.5909 |
| 17 | 0.8280 | 0.7505 | 0.8408 | 0.4935 |
| 19 | 0.9382 | 0.0158 | 0.9946 | 0.6698 |
| 20 | 0.9443 | 0.3970 | 0.9989 | 0.7313 |
| 22 | 0.9425 | 0.5886 | 0.9978 | 0.6664 |
| 23 | 0.9411 | 0.4559 | 0.9981 | 0.8564 |
| 24 | 0.9463 | 0.5060 | 1.0000 | 1.0000 |

According to the Table 2, when the target wind turbine is 6 #, seven turbines, namely 2 #, 8 #, 19 #, 20 #, 22 #, 23 # and # 24 among the 16 turbines have a linear wind direction correlation coefficient of about 0.94 with 6 #. When the target wind turbine is 24 #, the wind turbines of 2 #, 8 #, 14 #, 19 #, 20 #, 22 # and 23 # among the 16 turbines have a linear wind direction correlation coefficient of about 0.99 with 24 #. 0.94 and 0.99 are interpreted as highly correlated in the range of values of the Pearson correlation coefficient. It can be seen that in the same wind farm, the predicted target wind turbine has a low discriminant validity of wind direction correlation with other turbines, so that wind direction correlation cannot be used as an effective means of screening a correlated turbine.

The yaw time correlation coefficient is calculated by using the method for screening a correlated seed turbine for wind direction prediction proposed by the present invention. It can be seen that when the target wind turbine is 6 #, 17 # has the largest correlation coefficient, that is, Q_{17,6}=0.7505, and when the target wind turbine is 25 #, 23 # has the largest correlation coefficient, that is, Q_{23,6}=0.8564. Therefore, the discriminant validity of the correlation using the method of the present invention is significantly better than the linear wind direction correlation.

The above implementations are merely described as examples, and are not intended to limit the scope of the present invention. These implementations can also be implemented in various other ways, and various omissions, substitutions, and changes can be made without departing from the technical thought of the present invention.

What is claimed is:

1. A method for screening a correlated seed turbine for wind direction prediction, wherein the method comprises the following steps:
(1) modeling a yaw event of a wind turbine based on a wind direction, a wind speed and a yaw parameter, and obtaining a wind turbine yaw event flag of each wind turbine in a wind farm during a modeling period;
(2) classifying and counting the wind turbine yaw event flag, and obtaining a yaw correlation coefficient of other wind turbines each with a target wind turbine in the wind farm; and
(3) screening a seed turbine based on the yaw correlation coefficient.

2. The method for screening a correlated seed turbine for wind direction prediction according to claim 1, wherein in step (1), a value of the wind turbine yaw event flag is {−1,0,1}, wherein 1 indicates clockwise yaw, −1 indicates counterclockwise yaw, and 0 indicates no yaw.

3. The method for screening a correlated seed turbine for wind direction prediction according to claim 2, wherein step (1) is specifically:
performing steps (11) to (16) for a wind turbine n to obtain a wind turbine yaw event flag, n=1,2 . . . , k, wherein k is a total number of wind turbines in the wind farm:
(11) setting i=1, wherein Dₙⁱ is a yaw angle of the wind turbine n at an i^{th} moment; dₙⁱ is a measured wind direction of the wind turbine n at the i^{th} moment;
(12) obtaining a yaw angle Dₙ¹ of the wind turbine n at a 1^{st} moment:
Dₙ¹=dₙ¹;
(13) obtaining a yaw start angle Jₙⁱ of the wind turbine n at the i^{th} moment according to the following formula:
$${J}_{n}^{i} = \{ \begin{matrix}{deg}_{1} , {v}_{n}^{i} \geq {v}_{seg} \\ {deg}_{2} , {v}_{n}^{i} < {v}_{seg}\end{matrix}$$
wherein, vₙⁱ is a measured wind speed of the wind turbine n at the i^{th} moment; v_{seg} is a set segmented wind speed; deg₁ and deg₂ are set yaw start angles;
(14) calculating a wind deflection angle Δdₙⁱ of the wind turbine n at the i^{th} moment:
$$Δ {d}_{n}^{i} = \{ \begin{matrix}0 & i = 1 \\ {d}_{n}^{i} - {D}_{n}^{i - 1} & i > 1 ;\end{matrix}$$
(15) obtaining a wind turbine yaw event flag Pₙⁱ of the wind turbine n at the i^{th} moment and updating Dₙⁱ according to the following formulas:
$${P}_{n}^{i} = \{ \begin{matrix}1 & , & Δ {d}_{n}^{i} \geq {J}_{n}^{i} \\ - 1 & , & Δ {d}_{n}^{i} \leq - {J}_{n}^{i} \\ 0 & , & - {J}_{n}^{i} \leq Δ {d}_{n}^{i} \leq {J}_{n}^{i} ,\end{matrix} \\ {D}_{n}^{i} = \{ \begin{matrix}{d}_{n}^{i} & , {P}_{n}^{i} \neq 0 \\ {D}_{n}^{i - 1} & , {P}_{n}^{i} = 0 ;\end{matrix}$$
(16) assigning i=i+1, and determining whether i is less than n_{data}; if yes, returning to step (13), otherwise ending, wherein n_{data} is a total number of moments during the modeling period.

4. The method for screening a correlated seed turbine for wind direction prediction according to claim 2, wherein step (2) is specifically:
numbering the target wind turbine as n₂, and performing steps (21) to (23) for a wind turbine j in the wind farm to obtain a yaw correlation coefficient Q_{j,n}_{₂} of the wind turbine j with the target wind turbine in the wind farm, wherein, j=1,2, . . . , k and j≠ n₂, and k is a total number of wind turbines in the wind farm:
(21) counting a number of times L(1,1) when the wind turbine j and the target wind turbine both yaw with the same yaw event at adjacent moments during the modeling period, a number of times L(1,2) when the wind turbine j yaws but the target wind turbine does not yaw at adjacent moments during the modeling period, a number of times L(2,1) when the wind turbine j does not yaw but the target wind turbine yaws at adjacent moments during the modeling period, and a number of times L(2,2) when the wind turbine j and the target wind turbine both do not yaw at adjacent moments during the modeling period, according to the wind turbine yaw event flag; and
(22) calculating a yaw correlation coefficient Q_{j,n}_{₂} of the wind turbine j with the wind turbine n₂ according to L(1,1), L(1,2), L(2,1) and L(2,2).

5. The method for screening a correlated seed turbine for wind direction prediction according to claim 4, wherein step (21) is specifically:
(21a) counting a number of times n(a,b) when the wind turbine yaw event flag of the target wind turbine is b and the wind turbine yaw event flag of the wind turbine j at the next moment is a during the modeling period, according to the wind turbine yaw event flag, wherein a and b are {−1,0,1};
(21b) determining L(1,1), L(1,2), L(2,1) and L(2,2) according to the following formulas:
L(1,1),=n(1,1)+n(−1, −1)
L(1,2)=n(1,0)+n(−1,0)
L(2,1)=n(0,1)+n(0, −1)
L(2,2)=n(0,0)

6. The method for screening a correlated seed turbine for wind direction prediction according to claim 4, wherein in step (22), Q_{j,n}_{₂} is determined by the following formula:
$${Q}_{j , {n}_{2}} = \frac{L ( 1 , 1 ) \times L ( 2 , 2 ) - L ( 1 , 2 ) \times L ( 2 , 1 )}{L ( 1 , 1 ) \times L ( 2 , 2 ) + L ( 1 , 2 ) \times L ( 2 , 1 )} .$$

7. The method for screening a correlated seed turbine for wind direction prediction according to claim 1, wherein step (3) is specifically:
(31) comparing the yaw correlation coefficient of other wind turbines each with the target wind turbine in the wind farm; and
(32) screening a wind turbine with the strongest correlation as the correlated seed turbine for wind direction prediction.

8. The method for screening a correlated seed turbine for wind direction prediction according to claim 7, wherein in step (32), the wind turbine with the strongest correlation is screened according to the following formula:
$$j = arg {max}_{j} \{ {Q}_{1 , {n}_{2}} , {Q}_{2 , {n}_{2}} , ⋯ {Q}_{j , {n}_{2}} , ⋯ {Q}_{k , {n}_{2}} \}$$
wherein, n₂ is the number of the target wind turbine; Q_{j,n}_{₂} is the yaw correlation coefficient of the wind turbine j with the target wind turbine, j=1,2, . . . , k and j≠n₂, and k is a total number of wind turbines in the wind farm.
